(19) United States
(12) Patent Application Publication
(10) Pub. No.: US 2026/0061910 A1
(43) Pub. Date: Mar. 5, 2026

(54) AISLE ARMREST WITH SPRING-LOADED RELEASE LATCH

(71) Applicant: B/E Aerospace, Inc., Winston-Salem, NC (US)

(72) Inventors: Pallavi Doddenahalli Shekharappa, Hassan (IN); Shivakumara Alvi, Bangalore (IN); Sreekanth Rao, Bangalore (IN); Eric M. McKee, Oak Ridge, NC (US); Michael Schmid, Winston Salem, NC (US)

(21) Appl. No.: 19/250,823

(22) Filed: Jun. 26, 2025

(30) Foreign Application Priority Data
Sep. 4, 2024 (IN) 202441066969

(51) Int. Cl. B60N 2/75; B60N 2/90

(52) U.S. Cl. CPC B60N 2/753; B60N 2002/952

(57) ABSTRACT

An aisle armrest assembly for a passenger seat. The armrest assembly includes a static frame member defining a latch cavity, an armrest pivotally mounted to the static frame member and including a catch, and a latch assembly configured to latch the armrest in a deployed armrest condition. The latch assembly includes a transverse pivot shaft mounted through the latch cavity, a spring-loaded latch disposed in the latch cavity and pivotally mounted on the pivot shaft, and a torsion spring mounted on the pivot shaft configured to bias the spring-loaded latch toward a latched condition. I use, the latch may be released to allow the armrest to be moved to a stowed armrest condition.

### CROSS REFERENCE TO RELATED APPLICATION

This application claims the benefit of priority of Indian Provisional Patent Application No. 202441066969 filed Sep. 4, 2024, which is hereby incorporated by reference in its entirety.

### TECHNICAL FIELD AND BACKGROUND

The present disclosure relates generally to an armrest assembly for an aircraft passenger seat, and more particularly, to an armrest assembly for an aisle seat including a spring-loaded release latch for allowing the armrest to be moved to a stowed armrest position.

Passenger seats such as aircraft passenger seats may be equipped with armrests. Some armrests may be movable. For aisle seats, the Federal Aviation Administration (FAA) and Department of Transportation (DOT) require aisle armrests for main cabin seats to be movable to a temporary upright position to accommodate seating passengers with restricted motion.

Traditional FAA and DOT compliant armrest assemblies include latch assemblies carried on the moving armrest. Carried latch assemblies are difficult to operate, include many moving parts that increase the complexity and cost of the armrest, and scrape along the spreader as the armrest cycles. In addition, latch assemblies carried on the moving armrest are not robust to rigidly lock the armrest in the deployed position, causing vibration, noise, wear and looseness over time. Therefore, what is needed is a latch solution that overcomes the disadvantages of traditional latch assemblies for movable armrests.

### BRIEF SUMMARY

According to one aspect, the inventive concepts according to the present disclosure are directed to an armrest assembly. In embodiments, the armrest assembly includes a static frame member defining a latch cavity, an armrest pivotally mounted to the static frame member and including a catch, and a latch assembly mounted to the static frame member configured to latch the armrest in a deployed armrest condition. In embodiments, the latch assembly includes a transverse pivot shaft mounted through the latch cavity, a spring-loaded latch disposed in the latch cavity and pivotally mounted on the pivot shaft, and a spring mounted on the pivot shaft configured to bias the spring-loaded latch toward a latched condition.

In some embodiments, when the spring-loaded latch is in the latched condition, the armrest is prevented from pivoting from the deployed armrest condition to a stowed armrest condition.

In some embodiments, the spring-loaded latch includes a hook end configured to engage the catch, and a lever configured to pivot the spring-loaded latch toward the unlatched condition against a force of the torsion spring.

In some embodiments, the hook end and the lever are integrally formed.

In some embodiments, the hook end forms a cam for making sliding contact with the catch to urge the spring-loaded latch toward the unlatched condition as the armrest approaches the deployed armrest condition.

In some embodiments, the hook end is disposed inside the armrest when the armrest is in the deployed armrest condition.

In some embodiments, the latch cavity limits rotation of the spring-loaded latch in opposite directions.

In some embodiments, the catch is positioned inside the armrest along a bottom surface of the armrest.

In some embodiments, the armrest is flat when the armrest is in the deployed armrest position, and the armrest is upright when the armrest is in the stowed armrest position.

In some embodiments, the static frame member is a spreader defining an armrest pivot axis proximal to an upper end of the spreader.

According to another aspect, the inventive concepts according to the present disclosure are directed to an aisle armrest assembly for an aircraft passenger seat. In embodiments, the armrest assembly includes a spreader defining a latch cavity, an armrest pivotally mounted to the spreader, movable between a deployed armrest condition and a stowed armrest condition, and including a catch, and a latch assembly mounted to the spreader and configured to latch the armrest in the deployed armrest condition. In embodiments, the latch assembly includes a transverse pivot shaft mounted through the latch cavity, a spring-loaded latch disposed in the latch cavity and pivotally mounted on the pivot shaft, the spring-loaded latch movable between a latched condition in which the spring-loaded latch is engaged with the catch and an unlatched condition in which the spring-loaded latch is disengaged from the catch, and a torsion spring mounted on the pivot shaft and configured to bias the spring-loaded latch toward the latched condition.

In some embodiments, the spring-loaded latch includes a hook end configured to engage the catch, the spring-loaded latch includes a lever configured to pivot the spring-loaded latch toward the unlatched condition against a force of the torsion spring, and the hook end and the lever are integrally formed.

In some embodiments, the hook end forms a cam for making sliding contact with the catch to urge the spring-loaded latch toward the unlatched condition as the armrest approaches the deployed armrest condition.

In some embodiments, the hook end is disposed inside the armrest when the armrest is in the deployed armrest condition.

In some embodiments, the latch cavity limits rotation of the spring-loaded latch in opposite directions.

In some embodiments, the catch is positioned inside the armrest along a bottom surface of the armrest.

According to a further aspect, the inventive concepts according to the present disclosure are directed to a passenger seat assembly. In embodiments, the passenger seat assembly includes at least one transverse beam, a plurality of spreaders mounted to the at least one transverse beam, the plurality of spreaders including an aisle spreader, and a plurality of armrests pivotally mounted to the plurality of spreaders, the plurality of armrests including an aisle armrest pivotally mounted to the aisle spreader, and the aisle armrest including a catch. In use, the aisle armrest is configured to pivot between a deployed armrest position and a stowed armrest position, and the aisle armrest is configured to be latched in the armrest deployed position by a latch assembly. In embodiments, the latch assembly includes a transverse pivot shaft mounted through a latch cavity defined by the aisle spreader, a spring-loaded latch disposed in the latch cavity and pivotally mounted on the pivot shaft, the spring-loaded latch movable between a latched condition in which the spring-loaded latch is engaged with the catch and an unlatched condition in which the spring-loaded latch is disengaged from the catch, and a torsion spring mounted on the pivot shaft, the torsion spring configured to bias the spring-loaded latch toward the latched condition.

In some embodiments, the spring-loaded latch includes a hook end configured to engage the catch, the catch is disposed inside the armrest along a bottom surface of the armrest, the spring-loaded latch includes a lever configured to pivot the spring-loaded latch toward the unlatched condition against a force of the torsion spring, the hook end and the lever are integrally formed, and the hook end is disposed inside the armrest when the armrest is in the deployed armrest condition.

In some embodiments, the hook end forms a cam for making sliding contact with the catch to urge the spring-loaded latch toward the unlatched condition as the armrest approaches the deployed armrest condition.

In some embodiments, the passenger seat assembly is configured for installation in a main cabin of an aircraft.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is an isometric view of an armrest assembly including a release latch, in accordance with example embodiments of this disclosure;

FIGS. 2A and 2B are respective side and detailed views of the armrest assembly showing the armrest in a deployed armrest condition, in accordance with example embodiments of this disclosure;

FIG. 3A is a side view of the armrest assembly showing the armrest latched in the deployed armrest condition, in accordance with example embodiments of this disclosure;

FIG. 3B is a side view of the armrest assembly showing the armrest unlatched and in the stowed armrest condition, in accordance with example embodiments of this disclosure;

FIG. 3C is a side view of the armrest assembly showing the armrest approaching the deployed armrest condition and the latch interacting with the catch, in accordance with example embodiments of this disclosure; and

FIG. 4 is an isometric view of a passenger seat assembly including at least one movable aisle armrest, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to armrest assemblies including a latch for rigidly maintaining a movable armrest in a deployed armrest condition, and releasable to allow the armrest to be moved to a stowed armrest condition. As used herein, the term “deployed” refers to the armrest condition in which the armrest orientation is flat or substantially flat. The armrest may be positioned in the deployed armrest condition for use during flight. As used herein, the term “stowed” refers to the armrest condition in which the armrest orientation is upright or substantially upright. The armrest may be positioned in the stowed armrest condition when seating a passenger, for instance a disabled passenger requiring a lateral transition. The armrest is selectively movable between the deployed armrest condition and the stowed armrest condition. When in the deployed armrest condition, the armrest is rigidly locked in place. When unlatched, the armrest can be moved (e.g., pivoted) to the stowed armrest position. The latch is biased toward a latched condition such that, as the moving armrest approaches the deployed armrest position, the latch interacts with the armrest to automatically engage the armrest to achieve a latched condition.

In a particular conceived example, the armrest assembly is mounted to a passenger seat assembly and positioned along an aisle to facilitate lateral seat transfer for a disabled passenger. In some embodiments, the armrest stows alongside a seat back and deploys to a generally horizontal use position. The passenger seat assembly may be equipped with one or more movable armrest assemblies depending on the number of seats and number of aisles directly adjacent the passenger seat assembly. For instance, when installed in a main cabin between the fuselage and a longitudinal aisle, the passenger seat assembly may be equipped with one movable armrest according to the present disclosure and positioned alongside the aisle. When installed in a main cabin of a widebody airliner positioned between two longitudinal aisles, the passenger seat assembly may be equipped with two movable armrest assemblies with one positioned at each end of the row.

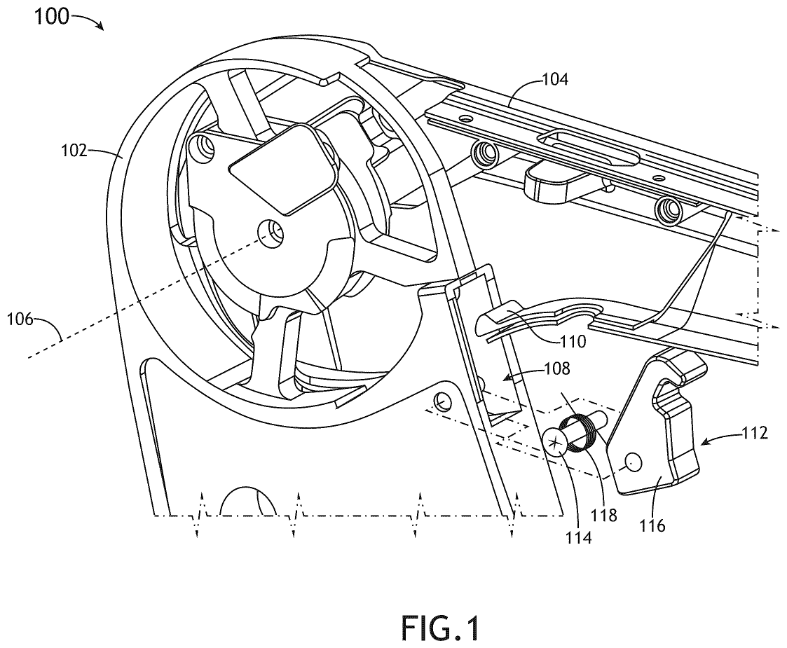

FIG. 1 illustrates an armrest assembly 100 according to the present disclosure. The armrest assembly 100 includes a static frame member 102 and an armrest 104 supported by and movably mounted to the static frame member 102. In embodiments, the static frame member 102 may be a spreader of a passenger seat assembly, and the armrest 104 may be pivotally mounted to an upper end of the spreader. The static frame member 102 defines a horizontal pivot axis 106 around which the armrest 104 rotates between the deployed armrest condition and the stowed armrest condition. The mechanism by which the static frame member 102 and the armrest 104 interface is not critical to the present disclosure and therefor may vary. For example, the armrest 104 may rotate around a shaft and the static frame member 102 may define hard stops for limiting armrest rotation in opposite directions.

The static frame member 102 defines a latch cavity 108. As shown, the latch cavity 108 may open along a ‘forward’ edge of the spreader. The armrest 104 includes a catch 110. In some embodiments, the catch 110 is positioned inside the armrest 104 along a bottom surface of the armrest 104. The armrest assembly 100 further includes a latch assembly 112 mounted to the static frame member 102. In use, the latch assembly 112 is configured to latch the armrest 102 in the deployed armrest condition and release the armrest 102 to allow the armrest 102 to be rotated to the stowed armrest condition.

In embodiments, the latch assembly 112 includes a transverse pivot shaft 114 mounted through the latch cavity 108, a spring-loaded latch 116 disposed in the latch cavity 108 and pivotally mounted on the pivot shaft 114, and a torsion spring 118 mounted on the pivot shaft 114. In other embodiments, alternative spring types may be used to bias the spring-loaded larch 116, for instance a leaf spring or a compression spring acting on the spring-loaded latch. In use, the spring-loaded latch 116 is movable between a latched condition in which the spring-loaded latch 116 is engaged with the catch 110, and an unlatched condition in which the spring-loaded latch 116 is disengaged from the catch 110. In use, the torsion spring 118 is configured to bias the spring-loaded latch 116 toward the latched condition.

The pivot shaft 114 may be a pin, screw or other fastener received in openings formed through the static frame member 102. The pivot shaft 114 is mounted transverse across the latch cavity 108 such that the spring-loaded latch 116 can be rotatably disposed in the latch cavity 108. The torsion spring 118 engages the spring-loaded latch 116 and the latch cavity 108 to bias the spring-loaded latch 116 toward the latched condition. For example, the torsion spring 118 may be energized when the spring-loaded latch 116 is ‘pushed’ toward the unlatched condition, and releases energy when the pushing force is released. In embodiments, the latch cavity 108 interacts with the spring-loaded latch 116 to limit rotation in opposite directions (e.g., hard stops).

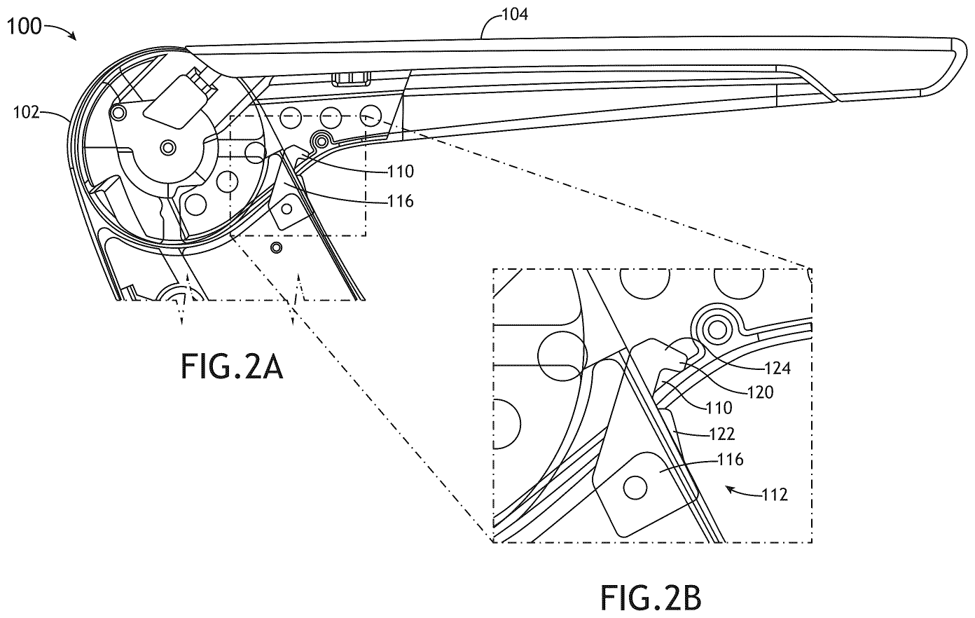

FIGS. 2A and 2B illustrate the armrest assembly 100 with the armrest 104 shown latched in the deployed armrest condition. When latched, the armrest 102 is prevented from pivoting toward the stowed armrest condition. In other words, the armrest 104 cannot be moved until the spring-loaded latch 116 is released from the catch 110. In embodiments, the spring-loaded latch 116 includes a hook end 120 configured to engage the catch 110, and a lever 122 configured to be pushed to pivot the spring-loaded latch 116 toward the unlatched condition against the force of the torsion spring 108. When in the unlatched condition, the spring-loaded latch 116 is disengaged from the catch 110. In embodiments, the hook end 120 and the lever 122 may be separate pieces or integrally formed.

The hook end 120 and the catch 110 interact to resist pulling forces. In other words, when the armrest 104 is pulled upward when the spring-loaded latch 116 is in the condition shown in FIG. 2B, the hook end 120 constrains motion of the catch thereby resisting armrest motion. The hook end 120 further forms a cam 124 for making sliding contact with the catch 110 to urge the spring-loaded latch 116 toward the unlatched condition as the armrest 104 approaches the deployed armrest condition. In other words, when the armrest 104 is being moved from the stowed armrest condition to the deployed armrest condition, the catch 110 makes sliding contact with the cam 124 which is an includes surface that causes the spring-loaded latch 116 to pivot toward the unlatched condition to allow the catch to moved past the hook end 120. Once the catch 110 has moved past the hook end 108, the energized torsion spring 108 causes the spring-loaded latch 116 to pivot back toward the latched condition into engagement with the catch 110. Thus, the latch assembly 112 operates to automatically latch when the armrest 104 is moved to the fully deployed armrest condition and does not release until the latch assembly 112 is manually actuated.

When in the latched condition, the hook end 120 is disposed inside the armrest 102. This conceals the retention part of the spring-loaded latch 116 and also the interface of the spring-loaded latch 116 and catch 100. In addition, the latch assembly 112 is positioned under the armrest 104 at junction of the armrest 104 and the static frame member 102 such that the latch assembly 112 is substantially concealed from view from above. By concealing the latch assembly 112 from view from above, passengers are not aware of the existence of the latch assembly 112 and therefore cannot operate the latch assembly 112. Instead, the latch assembly 112 is available for crew use during seating and deplaning passengers, for instance disabled passengers requiring lateral transfer to a transfer wheelchair.

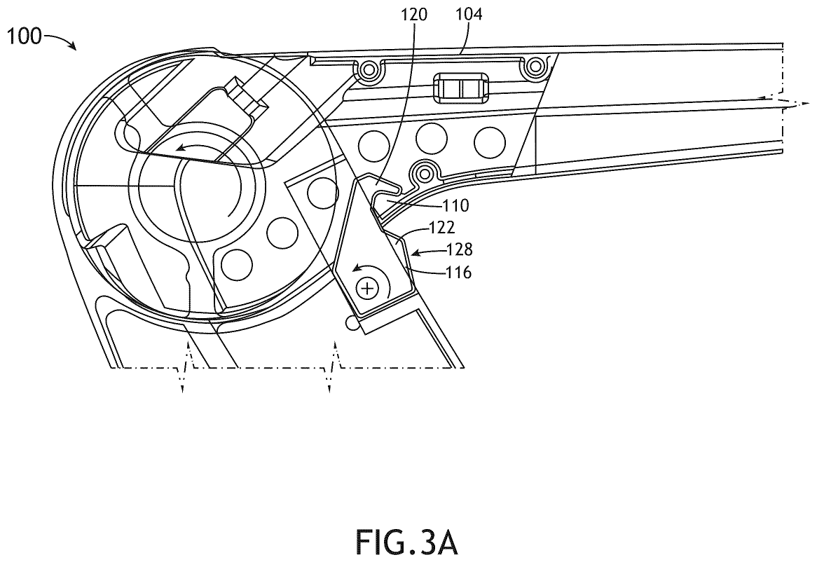

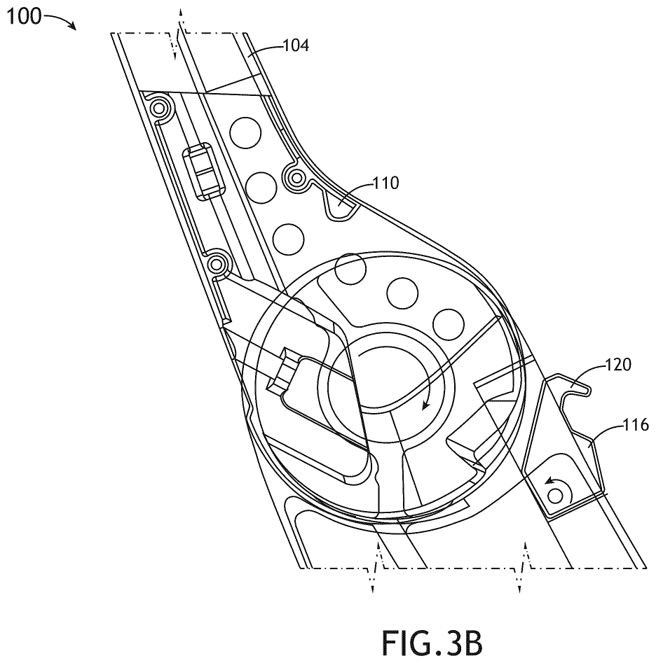

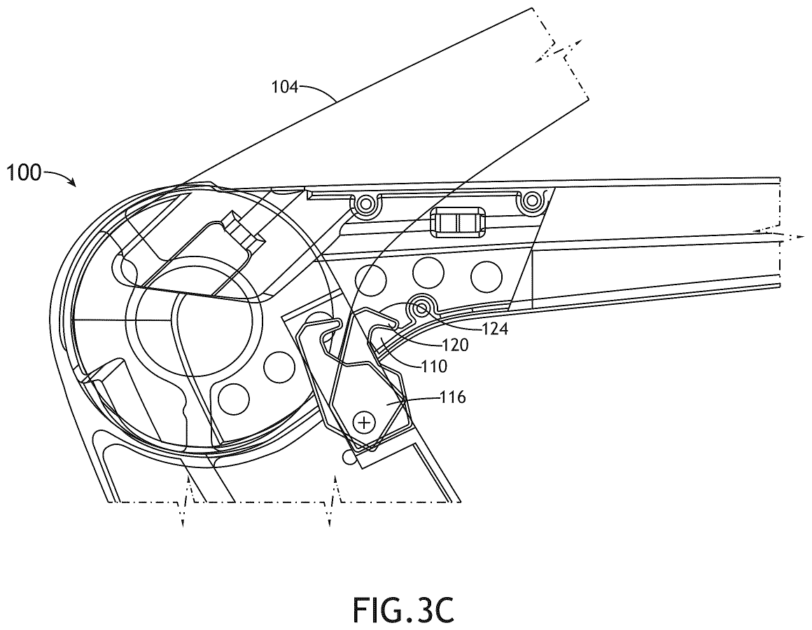

FIGS. 3A-C illustrate sequential motion of the armrest assembly 100. FIG. 3A shows the armrest 102 in the deployed armrest condition, and the latch assembly in the latched condition ready to be pressed. Pressing motion required to pivot the spring-loaded latch 116 out of engagement with the catch 110 is shown at directional arrow 128. In use, the lever 122 of the spring-loaded latch 116 is pressed to pivot the hook end 120 to the left as shown in the perspective of the drawing. FIG. 3B shows the armrest 104 in the stowed armrest condition and the spring-loaded latch 116 ready for the next latching use. In use, when the spring-loaded latch 116 is pressed, the armrest 104 is manually moved to a position in which the catch 110 is clear of the hook end 120. Once clear, the spring-loaded latch 116 can be released and the armrest 104 movement continued toward the stowed armrest condition. FIG. 3C shows the armrest 102 approaching the armrest deployed condition such that the catch 110 interacts with the cam 124 formed on the hook end 120 to cause the hook end 120 to pivot, to the left as shown in the drawing, to allow the catch 110 to clear the hook end 120. Once the catch 110 clears the hook end 120, the hook end 120 reengages ‘atop’ the catch 110 to maintain the latched condition.

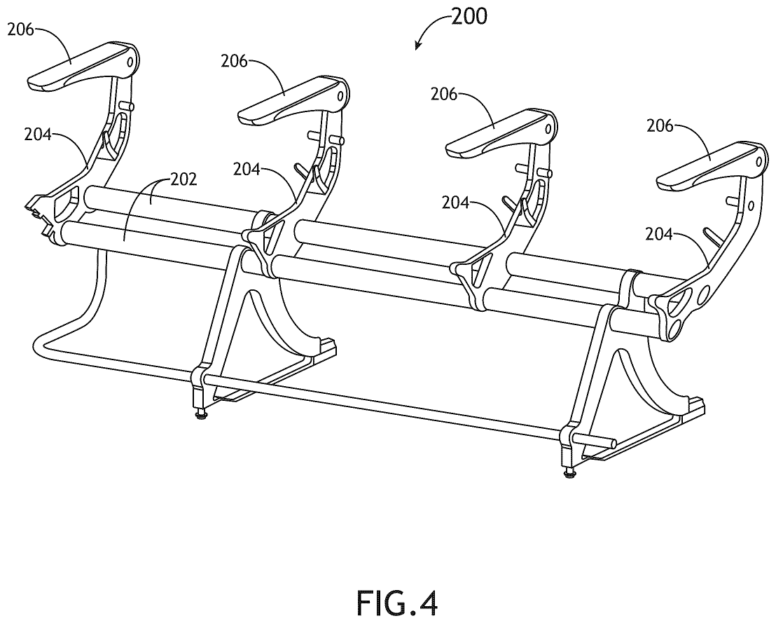

FIG. 4 illustrates a non-limiting example of a passenger seat assembly 200. In embodiments, the passenger seat assembly 200 is a seat row including at least one transverse beam 202, a plurality of spreaders 204 mounted to the at least one transverse beam 202, and a plurality of armrests 206 pivotally mounted to the plurality of spreaders. At least one of the end of row spreaders 204 and respective armrest 206 is an armrest assembly according to above capable motion between an armrest deployed position as show, and an armrest stowed position for seat ingress and egress. In some embodiments, the passenger seat assembly 200 is a row of seats configured for installation in a main cabin of an aircraft.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. An armrest assembly, comprising:
a static frame member defining a latch cavity;
an armrest pivotally mounted to the static frame member, the armrest movable between a deployed armrest condition and a stowed armrest condition, and the armrest including a catch; and
a latch assembly mounted to the static frame member, the latch assembly configured to latch the armrest in the deployed armrest condition, and the latch assembly including:
a transverse pivot shaft mounted through the latch cavity;
a spring-loaded latch disposed in the latch cavity and pivotally mounted on the pivot shaft, the spring-loaded latch movable between a latched condition in which the spring-loaded latch is engaged with the catch and an unlatched condition in which the spring-loaded latch is disengaged from the catch; and
a spring configured to bias the spring-loaded latch toward the latched condition.

2. The armrest assembly according to claim 1, wherein, when the spring-loaded latch is in the latched condition, the armrest is prevented from pivoting from the deployed armrest condition to the stowed armrest condition.

3. The armrest assembly according to claim 1, wherein the spring-loaded latch includes a hook end configured to engage the catch, and a lever configured to pivot the spring-loaded latch toward the unlatched condition against a force of the torsion spring.

4. The armrest assembly according to claim 3, wherein the hook end forms a cam for making sliding contact with the catch to urge the spring-loaded latch toward the unlatched condition as the armrest approaches the deployed armrest condition.

5. The armrest assembly according to claim 3, wherein the hook end is disposed inside the armrest when the armrest is in the deployed armrest condition.

6. The armrest assembly according to claim 1, wherein the spring is a torsion spring mounted on the transverse pivot shaft.

7. The armrest assembly according to claim 1, wherein the latch cavity limits rotation of the spring-loaded latch in opposite directions.

8. The armrest assembly according to claim 1, wherein the catch is positioned inside the armrest along a bottom surface of the armrest.

9. The armrest assembly according to claim 1, wherein the armrest is flat when the armrest is in the deployed armrest position, and the armrest is upright when the armrest is in the stowed armrest position.

10. The armrest assembly according to claim 1, wherein the static frame member is a spreader defining an armrest pivot axis proximal to an upper end of the spreader.

11. An aisle armrest assembly for an aircraft passenger seat, comprising:
a spreader defining a latch cavity,
an armrest pivotally mounted to the spreader, the armrest movable between a deployed armrest condition and a stowed armrest condition, and the armrest including a catch; and
a latch assembly mounted to the spreader, the latch assembly configured to latch the armrest in the deployed armrest condition, and the latch assembly including:
a transverse pivot shaft mounted through the latch cavity;
a spring-loaded latch disposed in the latch cavity and pivotally mounted on the pivot shaft, the spring-loaded latch movable between a latched condition in which the spring-loaded latch is engaged with the catch and an unlatched condition in which the spring-loaded latch is disengaged from the catch; and
a torsion spring mounted on the pivot shaft, the torsion spring configured to bias the spring-loaded latch toward the latched condition.

12. The aisle armrest assembly according to claim 11, wherein:
the spring-loaded latch includes a hook end configured to engage the catch;
the spring-loaded latch includes a lever configured to pivot the spring-loaded latch toward the unlatched condition against a force of the torsion spring; and
the hook end and the lever are integrally formed.

13. The aisle armrest assembly according to claim 12, wherein the hook end forms a cam for making sliding contact with the catch to urge the spring-loaded latch toward the unlatched condition as the armrest approaches the deployed armrest condition.

14. The aisle armrest assembly according to claim 12, wherein the hook end is disposed inside the armrest when the armrest is in the deployed armrest condition.

15. The aisle armrest assembly according to claim 12, wherein the latch cavity limits rotation of the spring-loaded latch in opposite directions.

16. The aisle armrest assembly according to claim 11, wherein the catch is positioned inside the armrest along a bottom surface of the armrest.

17. A passenger seat assembly, comprising:
at least one transverse beam;
a plurality of spreaders mounted to the at least one transverse beam, the plurality of spreaders including an aisle spreader; and
a plurality of armrests pivotally mounted to the plurality of spreaders, the plurality of armrests including an aisle armrest pivotally mounted to the aisle spreader, and the aisle armrest including a catch;
wherein the aisle armrest is configured to pivot between a deployed armrest position and a stowed armrest position; and
wherein the aisle armrest is configured to be latched in the armrest deployed position by a latch assembly including:
a transverse pivot shaft mounted through a latch cavity defined by the aisle spreader;
a spring-loaded latch disposed in the latch cavity and pivotally mounted on the pivot shaft, the spring-loaded latch movable between a latched condition in which the spring-loaded latch is engaged with the catch and an unlatched condition in which the spring-loaded latch is disengaged from the catch; and
a torsion spring mounted on the pivot shaft, the torsion spring configured to bias the spring-loaded latch toward the latched condition.

18. The passenger seat assembly according to claim 17, wherein:
the spring-loaded latch includes a hook end configured to engage the catch;
the catch is disposed inside the armrest along a bottom surface of the armrest;
the spring-loaded latch includes a lever configured to pivot the spring-loaded latch toward the unlatched condition against a force of the torsion spring;
the hook end and the lever are integrally formed; and
the hook end is disposed inside the armrest when the armrest is in the deployed armrest condition.

19. The passenger seat assembly according to claim 18, wherein the hook end forms a cam for making sliding contact with the catch to urge the spring-loaded latch toward the unlatched condition as the armrest approaches the deployed armrest condition.

20. The passenger seat assembly according to claim 17, configured for installation in a main cabin of an aircraft.
